(19) United States
(12) Patent Application Publication
(10) Pub. No.: US 2018/0164167 A1
(43) Pub. Date: Jun. 14, 2018

(54) Floor Mat Sensing System and Associated Methods

(71) Applicant: Wal-Mart Stores, Inc., Bentonville, AR (US)

(72) Inventors: Bruce W. Wilkinson, Rogers, AR (US); David Winkle, Bella Vista, AR (US); Todd Davenport Mattingly, Bentonville, AR (US)

(21) Appl. No.: 15/794,830

(22) Filed: Oct. 26, 2017

Related U.S. Application Data
(60) Provisional application No. 62/434,112, filed on Dec. 14, 2016.

(51) Int. Cl. G01L 1/16; A47G 27/02

(52) U.S. Cl. CPC G01L 1/16; A47G 27/02

(57) ABSTRACT

Described in detail herein are methods and systems for a sensing system. In exemplary embodiments, an array of sensors can be disposed in a floor mat disposed in a facility. The sensor can be configured to detect a set of attributes for any physical objects that pass over and come in contact with the floor mat. The sensors can encode the set of attributes in an electrical signal and transmit the electrical signal to a computing system. The computing system can decode the set of attributes from the electrical signal, determine a set of information based on the set of attributes and initiate one or more actions based on the set of information.

### CROSS-REFERENCE TO RELATED PATENT APPLICATIONS

This application claims priority to U.S. Provisional Application No. 62/434,112 filed on Dec. 14, 2016, the content of which is hereby incorporated by reference in its entirety.

### BACKGROUND

Monitoring activity in a large facility can be a slow and error prone process.

### BRIEF DESCRIPTION OF DRAWINGS

Illustrative embodiments are shown by way of example in the accompanying drawings and should not be considered as a limitation of the present disclosure:

FIG. 1A illustrates an exemplary floor mat with sensors according to embodiments of the present disclosure;

FIG. 1B is a schematic diagram of a system for monitoring activity in a facility using the floor mats with sensors according to embodiments of the present disclosure;

FIG. 1C illustrates an example sensor array embedded in a floor mat in accordance with a embodiments of the present disclosure;

FIG. 2 illustrates an exemplary distributed system for monitoring activity in a facility in accordance with embodiments of the present disclosure;

FIG. 3 illustrates an exemplary computing system in accordance with exemplary embodiments of the present disclosure; and

FIG. 4 is a flowchart illustrating an exemplary process for monitoring activity in a facility in accordance with embodiments of the present disclosure.

### DETAILED DESCRIPTION

Described in detail herein are apparatus, methods, and systems for a sensing system. In exemplary embodiments, a sensor array can be disposed in one or more floor mats which can be distributed in various locations in a facility. The floor mats with the sensor array can be configured to detect attributes of physical objects that pass over and come in contact with the floor mat. The sensors can encode the attributes in electrical signals and can transmit the electrical signals to a computing system, which can decode the electrical signals to extract the attributes, determine information based on the attributes and initiate one or more actions based on the information.

In exemplary embodiments, the sensing system can include a (first) floor mat and a two-dimension piezoelectric grid disposed on or in the floor mat. The two-dimensional piezoelectric grid can form a (first) sensor array of sensors. The sensor array can be configured to detect a (first) set of attributes associated with a (first) physical object in response to the physical object coming in contact with the first floor mat at a first time. The sensor array can encode the first set of attributes in one or more electrical signals (e.g., a first electrical signal) and can transmit the one or more electrical signals to a remote computing system that is communicatively coupled to the sensor array disposed on or in the floor mat. The computing system can be programmed to receive the one or more electrical signals, decode the first set of attributes from the one or more electrical signals, determine a set of information associated with the physical object based on the set of attributes, and initiate one or more actions in response based on the set of information.

The system can further include additional floor mats that each include a sensor array (e.g., a second floor mat that includes a second sensor array disposed on or in the second floor mat). The sensor array(s) in the additional floor mats can be configured to detect additional sets of attributes associated with physical objects in response to the physical objects passing over the additional floor mats at a second time. For example, a second floor mat including a second sensor array can be configured to detect a second physical object passing over the second floor mat at a second time and can encode a second set of attributes associated with the second physical object in one or more electrical signals (e.g., a second electrical signal) and can transmit the one or more electrical signals to the computing system. The computing system is further programmed to receive the one or more electrical signals from the second floor mat, decode the one or more electrical signals from the second floor mat, and determine a second set of information associated with the second physical object. The computing system can be programmed to determine the second physical object detected by the second floor mat is the same physical object detected by the first floor mat (e.g., the first physical object) based on the first set of attributes sensed for the first physical object by the first floor mat and the second set of attributes sensed for the second object by the second floor mat, and based on determining a difference between the first time and the second time is within a predetermined threshold. The computing system can be also programmed to determine a quantity of physical objects that are coming in contact with the first floor mat within a predetermined amount of time and can be configured to transmit an alert in response to determining a quantity of physical objects that coming in contact with the first floor mat is greater than a threshold.

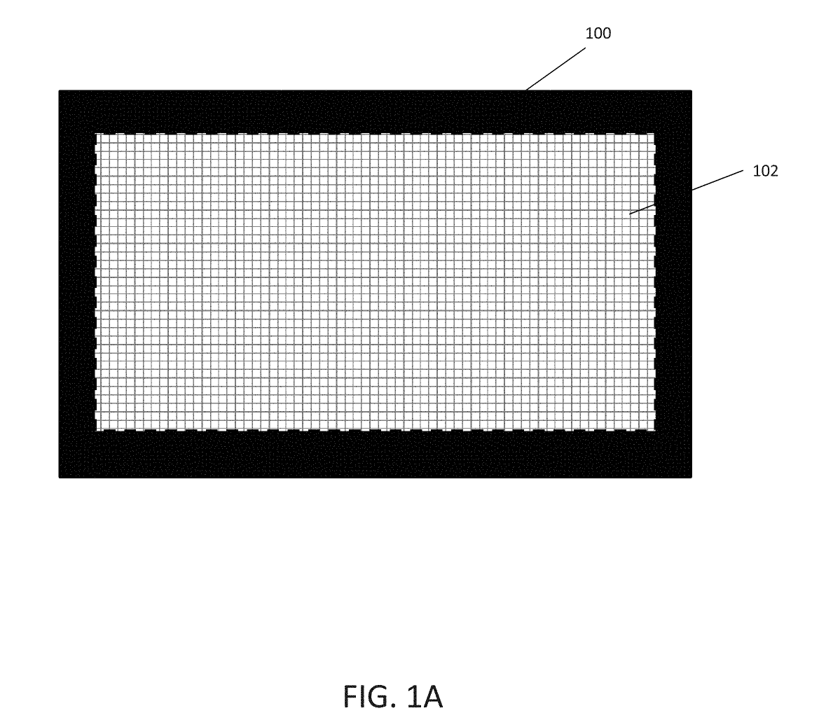

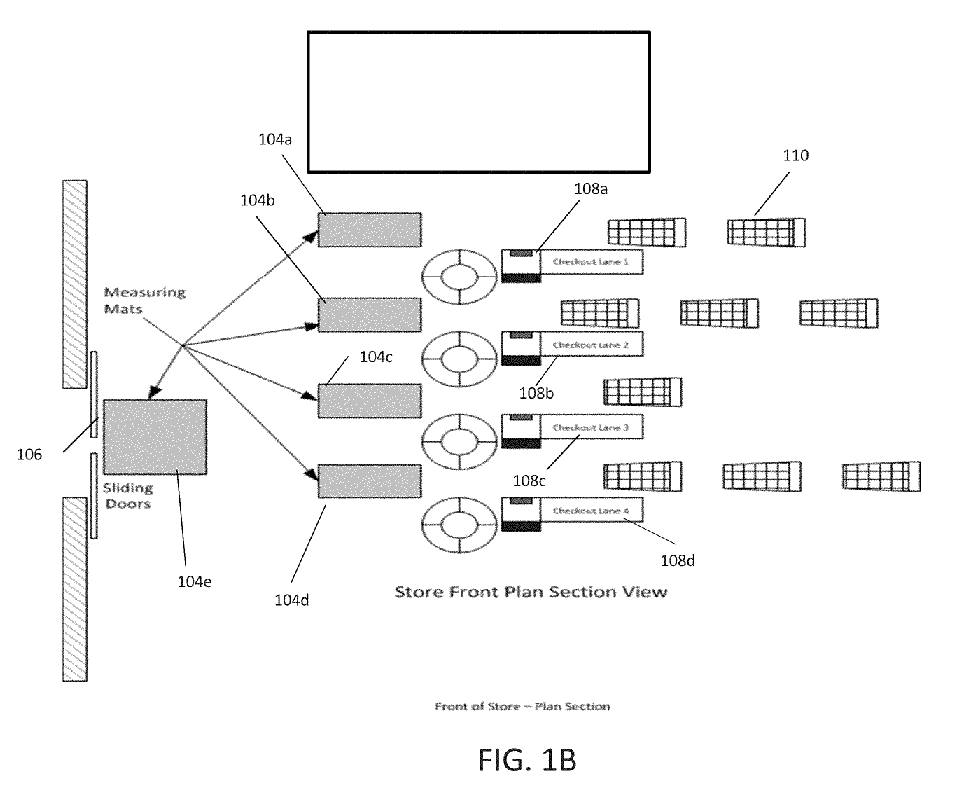

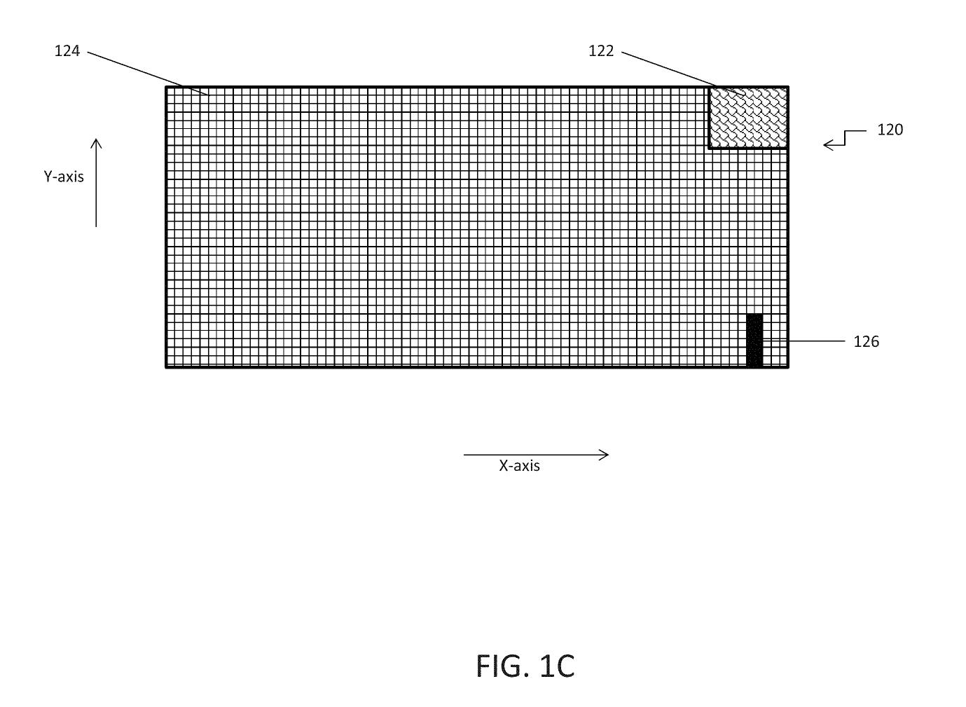

FIG. 1A is a block diagram of an exemplary floor mat 100 with sensors 102 according to the present disclosure. The floor mat 100 can be disposed in a facility and an array of sensors 102 can be disposed on or within the floor mat 100. For example, the sensors 102 can be embedded or attached to the floor mat 100. The sensors 102 can be formed by a two-dimensional grid of piezoelectric material. The sensors 102 can be configured to detect a set of attributes associated with physical objects which pass over and come in contact with the floor mat 100. Examples of physical objects can include people, carts, and/or other objects. The set of attributes detected by the sensors 102 can include, for example, a quantity of points of contact between a physical object and the floor mat (e.g., two feet, two wheels), a quantity of physical objects contacting the floor mat 100, a weight of the physical object(s), pressure imposed in the floor mat by the physical object(s), a temperature of the physical object(s), and moisture attributes associated with the physical object(s). The floor mat 100 can encode the set of attributes in one or more electrical signals and can transmit the electrical signal to a remote computing system. For example, the sensors 102 can detect the quantity of physical objects passing over the floor mat over a time period and can transmit one or more electrical signals that are indicative of the quantity of physical objects detected during the time period. As another example, the sensors 102 can detect liquid spilled on the floor mat 100 by detecting moisture or temperature.

FIG. 1B is a schematic diagram of a system for monitoring activity in a facility using the floor mats with sensors according to embodiments of the present disclosure. Floor mats 104a-e can be disposed at various locations in a facility. As a non-limiting example, the floor mats 104a-e can be disposed in a retail store. The floor mats 104a-d can be disposed adjacent to the checkout lanes 110a-d and the floor mat 104e can be disposed adjacent to the entrance/exit 106. The floor mats 104a-e can have an array of sensors disposed within them, which can be configured to detect a set of attributes associated with a physical objects as the physical objects pass over and come in contact with the floor mats 104a-e. The physical objects can be shopping carts 110 or people (not shown) in the retail store. For example, shopping carts 110 and people can be disposed in queues at checkout lanes 108a-d. The shopping carts 110 can contain products intended for purchase from the retail store. The sensors in floor mat 104a can detect a shopping cart from checkout lane 108a, rolling over the floor mat 104a. The sensors for floor mat 104a can detect a set of attributes associated with the cart, products contained in the cart and the person pushing the cart. For example, the sensors can detect the moisture, temperature, weight and quantity of physical objects passing over the floor mat 104a. The shopping cart 110 passing over the floor mat 104a can contain perishable products. As another example, one of the shopping carts 110 containing purchased products from checkout lane 108c can roll over floor mat 104c. The sensors in floor mat 104c can detect a set of attributes associated with the physical objects such as the shopping cart, the products contained in the shopping cart and the person pushing the shopping cart. For example, the sensors can detect the moisture, temperature, weight and quantity of physical objects passing over floor mat 104c.

The shopping carts 110 from checkout lane 108a and 108c can roll over the floor mat 104e disposed at the entrance 106 of the retail store within a predetermined time of one another. The sensors in the floor mat 104e can individually detect a set of attributes for each of the shopping carts 110 from checkout lanes 108a and 108c. The sensors in the floor mat 104e can detect that each of the shopping carts 110 is passing over the floor mat 104e at different portions of the floor mat 104 (e.g., based on the two dimensional piezoelectric grid that forms the sensors in embodiments of the present disclosure). The sensors of the floor mats 104a-e can encode the detected set of attributes into electrical signals and transmit the electrical signals to a remote computing system.

In some embodiments, customers can enter the retail store from the entrance 106. As the customers enter the retail store the customers can walk over the floor mat 104e. The sensors of the floor mat 104e can detect the weight of each customer as each customer can walk over a different portion of the two dimensional piezoelectric grid. The sensors of the floor mat 104e can encode the weight of the customers into electrical signals and transmit the electrical signals to a computing system. In some embodiments, the floor mats are disposed in various sections of the retail store. The sensors can detect a set of attributes associated with the customers and/or physical objects passing over the floor mats.

FIG. 1C illustrates an array of sensors in accordance with an exemplary embodiment. As discussed above an array of sensors 120 can be disposed in or attached to floor mats. The array of sensors 120 may be arranged as multiple individual sensor strips 122 extending along a length and width of the floor mats defining a sensing grid or matrix. The array of sensors 120 can be built into the floor mats itself or may be incorporated into a liner or mat disposed underneath or on top of the floor mats. Although the array of sensors 120 is shown as arranged to form a grid, the array of sensors can be disposed in other configurations. For example, the array of sensors 120 may also be in the form of rectangular sensor strips extending along either the x-axis or y-axis. The array of sensors 120 can detect attributes associated with the physical objects that are traveling on the floor mat, such as, for example, detecting pressure or weight indicating the presence or absence of merchandise at each individual sensor 124. In some embodiments, the surface of the floor mats is covered with an array of sensors 120 with sufficient discrimination and resolution so that, in combination, the sensors 124 are able to identify the quantity, and in some cases, the type of physical objects in the that pass over and come in contact with the floor mats.

The array of sensors 120 may be formed of piezoelectric material that can measure various characteristics, including pressure, force, and temperature. While a piezoelectric material forming piezoelectric sensors represent one suitable sensor type according to embodiments of the present disclosure, embodiments of the present disclosure can utilizes other sensor materials or types, such as, for example, other types of pressure/weight sensors (load cells, strain gauges, etc.).

The array of sensors 120 can be coupled to a radio frequency identification (RFID) device 126 with a memory having a predetermined number of bits equaling the number of sensors in the array of sensors 120 where each bit corresponds to a sensor 124 in the array of sensors 120. For example, the array of sensors 120 may be a 16×16 grid that defines a total of 256 individual sensors 124 may be coupled to a 256 bit RFID device 126 such that each individual sensor 124 corresponds to an individual bit. The RFID device 126 including a 256 bit memory may be configured to store the location information of the floor mat in attributes of physical objects passing over the floor mat. Based on detected changes in pressure, weight, and/or temperature, the sensor 124 may configure the corresponding bit of the memory located in the RFID device 126 (as a logic “1” or a logic “0”). The RFID device may then transmit the location of the floor mat and data corresponding to changes in the memory (associated with the attributes) to the computing system (e.g., in response to being read by an RFID reader communicatively coupled to the computing system).

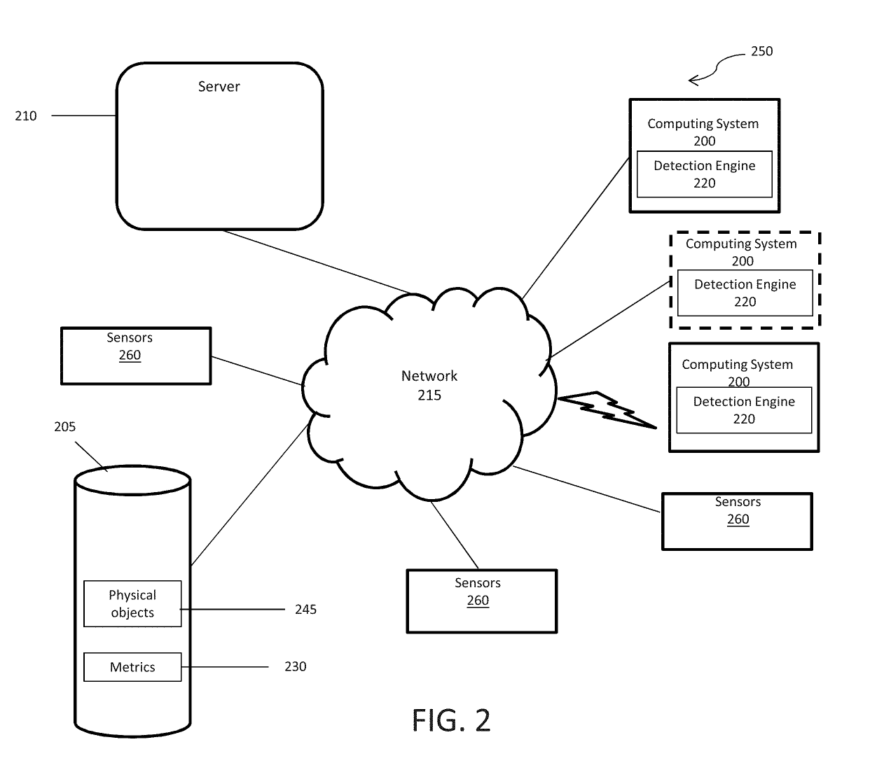

FIG. 2 illustrates an exemplary distributed system 250 for monitoring activity in a facility according to embodiments of the present disclosure. The system 250 can include one or more databases 205, one or more servers 210, one or more computing systems 200 and multiple instances of the sensors 260 disposed in floor mats distributed throughout one or more facilities. In exemplary embodiments, the computing system 200 is in communication with the databases 205, a server 210, and multiple instances of the sensors 260, via a communications network 215. The computing system 200 can implement at least one instance of the detection engine 220

In an example embodiment, one or more portions of the communications network 215 can be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

The server 210 includes one or more computers or processors configured to communicate with the computing system 200 and the databases 205, via the network 215. The server 210 hosts one or more applications configured to interact with one or more components of the computing system 200 and/or facilitates access to the content of the databases 205. The server 210 can also host the detection engine 220 discussed herein. The databases 205 may store information/data, as described herein. For example, the databases 205 can include a physical object database 245, and the metric database 230. The databases 205 and server 210 can be located at one or more geographically distributed locations from each other or from the computing system 200. Alternatively, the databases 205 can be included within server 210.

In exemplary embodiments, the computing system 200 can receive electrical signals from the sensors 260 in the floor mats. The computing system 200 can execute the detection engine 220 in response to receiving the electrical signals. The detection engine 220 can decode a set of attributes associated with physical objects from the electrical signals. The set of attributes can be one or more of: weight, moisture, temperature and quantity. The electrical signals can also include the location of the floor mat within the facility. The detection engine 220 can trigger an action based on the set of attributes associated with the physical object.

As a non-limiting example the sensors 260 can be disposed on floor mats disposed in a retail store. The floor mats can be disposed in the various sections of the retail store and customers, physical objects, and/or shopping carts can pass over and come in contact with the mats. The sensors can detect a set of attributes associated with the customers, physical objects and/or shopping carts.

In one example, a floor mat incorporated with sensors 260 can disposed at the entrance of the retail store. The sensors 260 can detect the customers, physical objects and/or shopping carts as they pass over and come in contact with the floor mat. The sensors can encode the detection of the multiple objects passing over the floor mat into electrical signals and transmit the electrical signals to the computing system 200. The computing system 200 can execute the detection engine 220 in response to receiving the electrical signals. The detection engine 220 can decode the quantity of physical objects passing over the floor mat. The detection engine 220 can determine the traffic of the retail store based on the decoded quantity of psychical objects passing over the floor mat.

In another example, the sensors 260 of a first floor mat disposed in an entrance of a first section can detect the weight of a customer as the customer enters the section. The customer can enter the first section with a shopping cart. The sensors 360 can encode the weight of the customer and the shopping cart into a first electrical signal and transmit the first electrical signal to the computing system 200. Sensors 260 of a second floor mat disposed at the exit of the first section of the store can detect the weight of the same customer and the shopping cart as the customer exits the section. The sensors 260 can encode the detected weight into a second electrical signal and transmit the second electrical signal to the computing system. The sensors 260 of the first and second floor mat can distinguish the customer and the shopping cart, as the customer and shopping cart pass over and come in contact with the first and second floor mat as they customer and shopping cart will pass over and come in contact with different portions of the floor mat (e.g., as determined based on the two dimensional piezoelectric grid implemented in embodiments of the present disclosure). The sensors 260 of the first and second floor mat can also encode the location of the first and second floor mats into the first and second electrical signals.

The computing system 200 can receive the first and second electrical signals from the sensors 260 of the first and second floor mat. The computing system 200 execute the detection engine 220 in response to receiving the first and second electrical signals. The sensors 260 can be coupled to an RFID device. The RFID device can communicate the electrical signals to the detection engine 220 (e.g., via an RFID reader). The first set of attributes can be a change in weight, temperature and moisture on the floor mat. The detection engine 220 can decode the weight of the customer, the weight of the shopping cart and location of the first and second floor mats from the first and second electrical signals. The detection engine 220 can compare the weight of the customer decoded from the first electrical signal with the weight of the customer decoded from the second electrical signal and determine the decoded weight is the weight of the same customer. The detection engine 220 can determine the shopping cart is being operated by the customer based on the shopping cart and customer being within a predetermined distance of one another on the first and second floor mat The detection engine 220 can determine how much time the customer spent in the first section of the store based the time interval between receiving the first electrical signal and the second electrical signal. Furthermore, the detection engine 220 can compare the weight of the shopping cart as the shopping cart entered the first section and the weight of the shopping cart as the shopping cart exited the first section or the facility based on the first and second electrical signals. The detection engine 220 can determine the customer has deposited a product disposed in the from the first section into the shopping cart based on the comparison. In some embodiments, the detection engine 220 can query the metrics database 230 to determine the weight of a shopping cart. The detection engine 220 can subtract the weight of the shopping cart without products deposited in the basket from the detected weight of the shopping cart by the sensors 260 of the first and second floor mat, to determine the weight of physical objects inside the shopping carts. The detection engine 220 can query the physical objects database 245 using the location of the first and second floor mats to determine which physical objects are disposed in the first section. The detection engine 220 can transmit an alert to a store employee based on the determined physical objects disposed in the first section. For example, the detection engine 220 can determine the products disposed in the first section need replenishment.

In another example, a floor mat with sensors 260 can be disposed near a perishable item section of the retail store. The customers can pass over and come in contact with the floor mat with shopping carts containing perishable items in the basket of the shopping cart. The customer can also carry the perishable items without a shopping cart. The sensors 260 can detect moisture emitted by the perishable items as they pass over and come in contact with the floor mat. The sensors 260 can encode the moisture into electrical signals and transmit the electrical signal to the computing system 200. The computing system 200 can execute the detection engine 220 in response to receiving the electrical signals.

The detection engine 220 can decode the moisture and location of the floor mat from the electrical signals. The detection engine 220 can query the physical objects database 245 using the location of the floor mat to determine the physical objects disposed in the location of the floor mat. The detection engine 220 can query the metrics database 230 to determine the moisture generated by the physical objects disposed in the location of the floor mat. The detection engine 220 can compare the moisture decoded from the electrical signals with the determined moisture generated by the physical objects disposed in the location of the floor mat. In response to determining the moisture is greater than a threshold amount, the detection engine 220 can determine the perishable items carried by the customers or contained in the shopping cart are damaged or decomposing. The detection engine 220 can transmit an alert to a store employee regarding the damaged and/or decomposing perishable items.

In some embodiments, the sensors 260 can detect the weight of each physical object contacting the floor mat based on the weight received by the floor mat in localized areas of the grid of sensors 260. For example, a first physical object can contact a first area of the floor mat and a second physical object can contact a second area of the floor mat. Accordingly, the first and second physical objects can contact different areas of the grid. The sensors 260 can detect a first weight of the first physical object received in a first area of the floor mat and a second weight of the second physical objects received in a second area of the floor mat. The sensors 260 can encode the first and second weight into electrical signals and transmit the electrical signals to the computing system 200. The computing system can execute the detection engine 220 in response to receiving the electrical signals. The detection engine can decode the first and second weight from the electrical signals. The detection engine 220 can query the physical objects database 245 to retrieve the possible products that are correlated with the first and second weight of the first and second physical objects. The detection engine 220 can transmit an alert based on the retrieved possible product that are correlated with the first and second weight of the first and second physical objects.

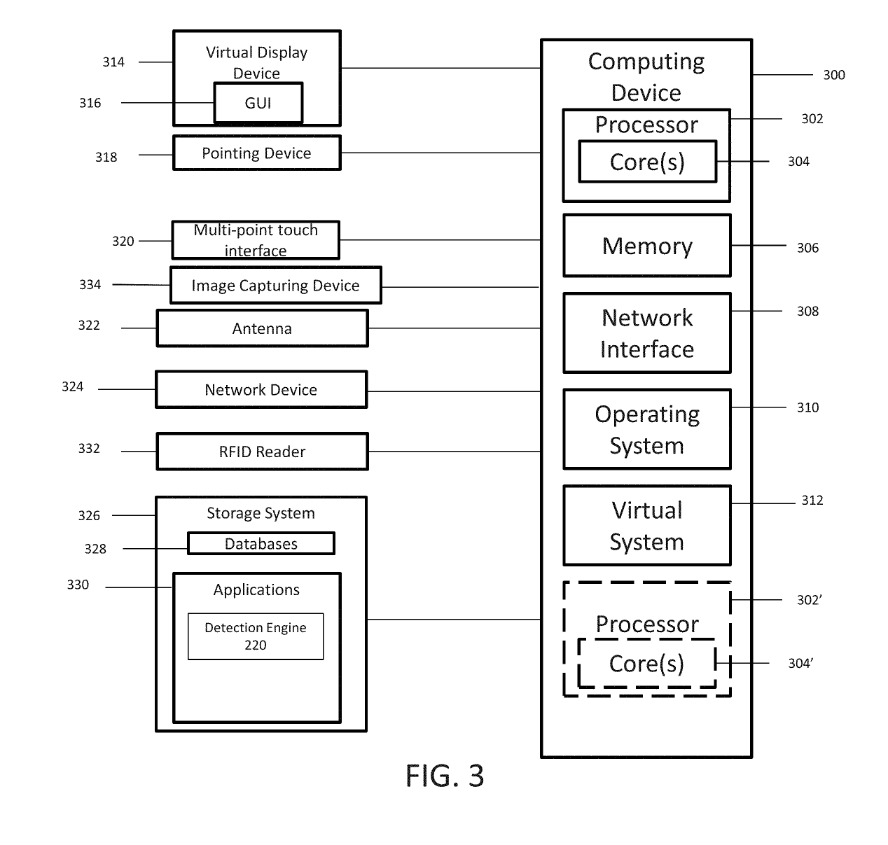

FIG. 3 is a block diagram of an example computing device for implementing exemplary embodiments of the present disclosure. Embodiments of the computing device 300 can implement embodiments of the floor mat sensing system. The computing device 300 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives, one or more solid state disks), and the like. For example, memory 306 included in the computing device 300 may store computer-readable and computer-executable instructions or software (e.g., applications 330) for implementing exemplary operations of the computing device 300. The computing device 300 also includes configurable and/or programmable processor 302 and associated core(s) 304, and optionally, one or more additional configurable and/or programmable processor(s) 302′ and associated core(s) 304′ (for example, in the case of computer systems having multiple processors/cores), for executing computer-readable and computer-executable instructions or software stored in the memory 306 and other programs for implementing exemplary embodiments of the present disclosure. Processor 302 and processor(s) 302′ may each be a single core processor or multiple core (404 and 404′) processor. Either or both of processor 302 and processor(s) 302′ may be configured to execute one or more of the instructions described in connection with computing device 300.

Virtualization may be employed in the computing device 300 so that infrastructure and resources in the computing device 300 may be shared dynamically. A virtual machine 312 may be provided to handle a process running on multiple processors so that the process appears to be using only one computing resource rather than multiple computing resources. Multiple virtual machines may also be used with one processor.

Memory 306 may include a computer system memory or random access memory, such as DRAM, SRAM, EDO RAM, and the like. Memory 406 may include other types of memory as well, or combinations thereof.

The computing device 300 can receive data from input/output devices such as an image capturing device 334 and/or RFID reader 332.

A user may interact with the computing device 300 through a visual display device 314, such as a computer monitor, which may display one or more graphical user interfaces 316, multi touch interface 320 and a pointing device 318.

The computing device 300 may also include one or more storage devices 326, such as a hard-drive, CD-ROM, or other computer readable media, for storing data and computer-readable instructions and/or software that implement exemplary embodiments of the present disclosure (e.g., applications) for implementing embodiments of the present disclosure. Exemplary storage device 326 can include one or more databases 328 for storing information regarding the physical objects. The databases 328 may be updated manually or automatically at any suitable time to add, delete, and/or update one or more data items in the databases. The databases 328 can include information such as physical objects database 245 and metrics database 230. The physical objects database 245 can store information regarding physical objects disposed in the facility. The metrics database 230 can store information associated with objects causing the coming in contact with the floor mats (e.g., a weight of an unloaded/loaded cart).

The computing device 300 can include a network interface 308 configured to interface via one or more network devices 324 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the computing system can include one or more antennas 322 to facilitate wireless communication (e.g., via the network interface) between the computing device 300 and a network and/or between the computing device 300 and other computing devices. The network interface 308 may include a built-in network adapter, network interface card, PCMCIA network card, card bus network adapter, wireless network adapter, USB network adapter, modem or any other device suitable for interfacing the computing device 300 to any type of network capable of communication and performing the operations described herein.

The computing device 300 may run any operating system 310, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device 300 and performing the operations described herein. In exemplary embodiments, the operating system 310 may be run in native mode or emulated mode. In an exemplary embodiment, the operating system 310 may be run on one or more cloud machine instances.

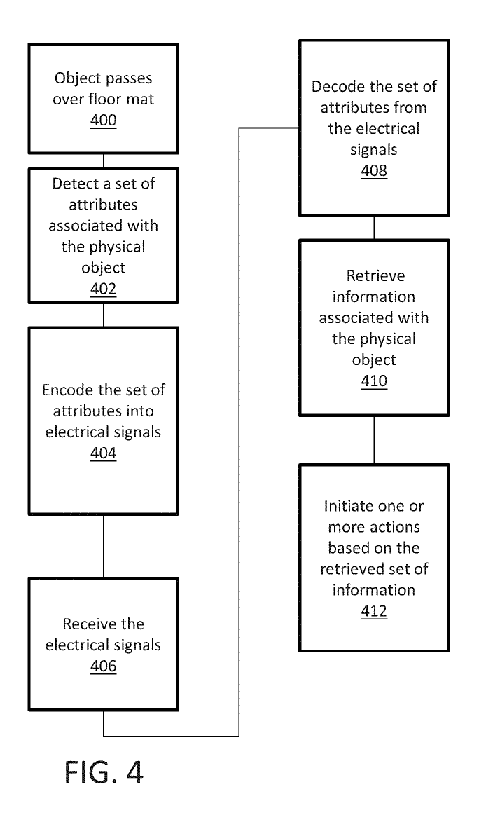

FIG. 4 illustrates a flowchart of the floor mat detection system according to the present disclosure. In operation 400, a physical object passes over floor mat (e.g. floor mat 100 and 104a-e shown in FIGS. 1A-B) disposed in a facility. Sensors (e.g. sensors 102 and 120 as shown in FIGS. 1A and 1C) can be disposed within the floor mat. The sensors can be formed by a two-dimension piezoelectric grid. The physical object can be a person or a cart. In operation 402, the sensors can detect a set of attributes associated with the physical object. The set of attributes can include one or more of: quantity, weight, moisture, and/or temperature.

In operation 404, the sensors can encode the set of attributes into electrical signals. The sensors can transmit the electrical signals to a computing system (e.g. computing system 200 as shown in FIG. 2). In operation 406, the computing system can receive the electrical signals. The computing system can execute the detection engine (e.g. detection engine 220 as shown in FIGS. 2-3). In operation 408, the detection engine can decode the set of attributes from the electrical signals.

In operation 410, the detection engine can query the physical objects database (e.g. physical objects database 245 as shown in FIG. 2) and/or the metrics database (e.g. metrics database 230 as shown in FIG. 2) to retrieve information associated with the physical object which passed over the floor mat. In operation 412, the detection engine can initiate one or more actions based on the retrieved set of information. For example, the detection engine can execute an alarm in the facility, transmit an alert and/or update the physical objects database based on retrieved set of information and/or the detected set of attributes.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a multiple system elements, device components or method steps, those elements, components or steps may be replaced with a single element, component or step. Likewise, a single element, component or step may be replaced with multiple elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the present disclosure. Further still, other aspects, functions and advantages are also within the scope of the present disclosure.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

We claim:

1. A sensing system, comprising:
a first floor mat;
a two-dimension piezoelectric grid disposed on or in the first floor mat, the two-dimensional piezoelectric grid forming a first array of sensors configured to (i) detect a first set of attributes associated with a physical object in response to the physical object coming in contact with the first floor mat at a first time, (ii) encode the first set of attributes in a first electrical signal, and (iii) transmit the first electrical signal; and
a computing system operatively coupled to the first array of sensors disposed on or in the first floor mat, the computing system programmed to receive the first electrical signal, decode the first set of attributes from the first electrical signal, determine a set of information associated with the first physical object based on the first set of attributes, and determine a quantity of physical objects that contact the first floor mat within a predetermined amount of time.

2. The system of claim 1, wherein the first array of sensors can detect, pressure, temperature, or moisture.

3. The system of claim 1, further comprising:
a second floor mat; and
a second array of sensors disposed on or in the second floor mat.

4. The system of claim 3, wherein the second array of sensors is configured to (i) detect a second set of attribute associated with a second physical object in response to the second physical object passing over the second floor mat at a second time, (ii) encode the second set of attributes in a second electrical signal, and (iii) transmit the second electrical signal to the computing system.

5. The system in claim 4, wherein the computing system is further programmed to receive the second electrical signal, decode the set of second set of attributes from the second electrical signal, and determine a second set of information associated with the second physical object.

6. The system of claim 5, wherein the computing system is programmed to determine the second physical object is the first physical object based on the first set of attributes of the first physical object and the second set of attributes of the second object, and based on determining a difference between the first time and the second time is within a predetermined threshold.

7. The system in claim 5, wherein the first set of attributes includes one or more of: a weight, a temperature, or a duration for which the first physical object was on the floor mat.

8. The system in claim 1, wherein the computing system is further programmed to transmit an alert in response to determining a quantity of physical objects that coming in contact with the first floor mat are greater than a predetermined threshold.

9. A sensing method, comprising:
detecting, via a first array of sensors formed by a two-dimension piezoelectric grid disposed on or in a first floor mat disposed at a first location of a facility, a first set of attributes associated with a physical object in response to the physical object coming in contact with the first floor mat at a first time,
encoding, via the first array of sensors, the first set of attributes in a first electrical signal; and
transmitting, via the first array of sensors, the first electrical signal;
receiving, via a computing system operatively coupled to the first array of sensors disposed on or in the first floor mat, the first electrical signal,
decoding, via the computing system, a first set of attributes from the first electrical signal;
determining, via the computing system, a set of information associated with the first physical object based on the first set of attributes; and
initiating, via the computing system, one or more actions based on the set of information.
determining, via the computing system, a quantity of physical objects that contact the first floor mat within a predetermined amount of time.

10. The method of claim 9, wherein the first array of sensors can detect, pressure, temperature, or moisture.

11. The method of claim 9, wherein a second array of sensors is disposed on or in a second floor mat disposed at a second location of the facility.

12. The method of claim 11, further comprising:
detecting, via a second array of sensors, a second set of attribute associated with a second physical object in response to the second physical object passing over the second floor mat at a second time;
encoding via the second array of sensors the second set of attributes in a second electrical signal; and
transmitting, via the second array of sensors, the second electrical signal to the computing system.

13. The method in claim 12, further comprising:
receiving, via the computing system is the second electrical signal;
decoding, via the computing system, the set of second set of attributes from the second electrical signal; and
determining, via the computing system, a second set of information associated with the second physical object.

14. The method of claim 13, further comprising determining, via the computing system, the second physical object is the first physical object based on the first set of attributes of the first physical object and the second set of attributes of the second object, and based on determining a difference between the first time and the second time is within a predetermined threshold.

15. The method in claim 14, wherein the first set of attributes includes one or more of: a weight, a temperature, or a duration for which the first physical object was on the floor mat.

16. The method in claim 9, transmitting, via the computing system, an alert in response to determining the quantity of physical that was in contact with the first floor mat are greater than a predetermined threshold.

17. A sensing system, comprising:
a first floor mat;
a second floor mat;
a two-dimension piezoelectric grid disposed on or in the first floor mat, the two-dimensional piezoelectric grid forming a first array of sensors configured to (i) detect a first set of attributes associated with a physical object in response to the physical object coming in contact with the first floor mat at a first time, (ii) encode the first set of attributes in a first electrical signal, and (iii) transmit the first electrical signal; and
a two-dimension piezoelectric grid disposed on or in the second floor mat, the two-dimensional piezoelectric grid forming a second array of sensors configured to (i) detect a second set of attributes associated with a physical object in response to the physical object coming in contact with the second floor mat at a first time, (ii) encode the second set of attributes in a second electrical signal, and (iii) transmit the second electrical signal; and
a computing system operatively coupled to the first array of sensors disposed on or in the first floor mat, the computing system programmed to receive the first electrical signal, decode the first set of attributes from the first electrical signal, determine a set of information associated with the first physical object based on the first set of attributes, initiate one or more actions based on the set of information, receive the second electrical signal, decode the set of second set of attributes from the second electrical signal, determine a second set of information associated with the second physical object, determine the second physical object is the first physical object based on the first set of attributes of the first physical object and the second set of attributes of the second object, and based on determining a difference between the first time and the second time is within a predetermined threshold.

18. The system of claim 17, wherein the first set of attributes includes one or more of: a weight, a temperature, or a duration for which the first physical object was on the floor mat.
